(19) United States
(12) Patent Application Publication
(10) Pub. No.: US 2010/0186778 A1
(43) Pub. Date: Jul. 29, 2010

(54) Automated Wash System for Industrial Vehicles

(76) Inventor: Gregg Martin, Winnipeg (CA)

Correspondence Address: ADE & COMPANY INC., 2157 Henderson Highway, WINNIPEG, MB, R2G1P9, CA

(21) Appl. No.: 12/362,982

(22) Filed: Jan. 30, 2009

Related U.S. Application Data
(60) Provisional application No. 61/146,941, filed on Jan. 23, 2009.

(51) Int. Cl. B08B 3/04

(52) U.S. Cl. 134/34; 134/113

(57) ABSTRACT

An industrial vehicle wash system comprises a wash area receiving the vehicle and a separate control area receiving an operator. A plurality of wash modules are supported in the wash are to direct respective jets of wash fluid onto the vehicle. A controller varies orientation of the wash modules according to respective wash patterns. Cameras associated with the wash modules provide a visual display of the vehicle being washed to the operator in the control area. Using an operator input in the control area, the operator can interrupt the wash pattern of one wash module to provide additional washing to one area of the vehicle under manual operator control while the other wash modules continue to wash the vehicle according to the respective wash patterns thereof. The interrupted wash pattern can be resumed upon completion of the additional washing.

This application claims the benefit under 35 U.S.C. 119(e) of U.S. provisional application Ser. No. 61/146,941, filed Jan. 23, 2009.

### FIELD OF THE INVENTION

The present invention relates to an automated industrial vehicle wash system comprises at least one wash nozzle assembly to be directed at a vehicle in a wash area to follow a pre-programmed wash pattern in which the position of the nozzle assembly can be monitored by an operator in a remotely located control area.

### BACKGROUND

Heavy haulers are commonly used in the mining industry or in varying earth moving applications. These large vehicles are required to be washed periodically for maintenance. Washing of these vehicles is often accomplished by an operator located in proximity to the vehicle for directing a wash nozzle assembly at the vehicle under manual control. In order to protect the operator, typically only a limited number (e.g. 1 or 2) wash nozzle assemblies are used at one time. Washing the entire vehicle with such a limited number of wash nozzle assemblies consumes considerable time. As the vehicle is not able to be used in a productive manner during the washing period, decreasing the washing time is desirable for increasing the productive use of the vehicle.

### SUMMARY OF THE INVENTION

According to one aspect of the invention there is provided a wash system for an industrial vehicle comprising:

a wash area arranged for receiving the industrial vehicle therein;

a supply of wash fluid;

at least one wash module supported in the wash area, said at least one wash module comprising a nozzle assembly arranged to receive the wash fluid from the supply and direct the wash fluid in a high pressure jet onto the vehicle;

a camera associated with said at least one wash module and arranged to capture images of the high pressure jet directed onto the vehicle from said at least one wash module;

a control area separate from the wash area and arranged to receive an operator therein;

at least one display monitor in the control area arranged to display the images captured by the camera associated with said at least one wash module;

a main controller arranged to controllably vary orientation of the nozzle assembly of said at least one wash module according to a prescribed wash pattern; and

an operator input in the control area arranged to selectively vary the prescribed wash pattern of the nozzle assembly of said at least one wash module responsive to an input from an operator in the control area.

By providing an automated wash system permitting operators to be located remotely from the wash area, many nozzle assemblies (e.g. 6 or more) can be directed at the vehicle at the same time to significantly decrease the wash time of the vehicle. Furthermore by operating the nozzle assemblies according to specific wash patterns, the jet from a wash nozzle assembly can be directed across the vehicle in an optimal manner to ensure even and complete coverage while minimizing the wasted wash water and time. Also a single operator can monitor the wash programs of multiple wash modules at the same time. Relocating the operator to a remote location further increases safety for the operator.

The operator input may be arranged to vary the prescribed wash pattern of the main controller by being arranged to: interrupt the wash pattern at a prescribed program location; provide auxiliary control of said at least one wash module for a prescribed duration, and resume the prescribed wash pattern at the prescribed program location when the prescribed duration of the auxiliary control of the wash module is complete.

The operator input may comprise a manual controller arranged to manually vary orientation of the nozzle assembly of said at least one wash module under operator control during auxiliary control of said at least one wash module.

When there is provided a plurality of wash modules, each having a prescribed wash pattern, the main controller may be commonly associated with the plurality of wash modules so as to be arranged to operate at least some of the plurality of wash modules simultaneously with one another and so as to be arranged to independently control each of the wash modules according to the respective prescribed wash pattern thereof.

The operator input may be arranged to selectively vary the prescribed wash pattern of the nozzle assembly of a selected one of the plurality of wash modules and the main controller may be arranged to operate at least some of the other ones of the plurality of wash modules according to the respective prescribed wash pattern thereof during operation of the operator input to vary the prescribed wash pattern of the selected one of the wash modules.

The plurality of wash modules may be supported at fixed locations about a perimeter of the wash area such that the nozzle assembly of each wash module is supported to vary orientation of the nozzle assembly at the respective fixed location thereof. The wash modules at fixed locations are preferably supported in the wash area at different elevations and along opposing sides of the wash area.

When there is provided a mobile wash module supported on a cart for rolling movement along the ground; the cart preferably comprises a position motor arranged to selectively position the cart within the wash area; and the main controller is preferably arranged control the position motor to position the cart according to the prescribed wash pattern

The nozzle assembly and the camera of said at least one wash module are preferably movable to vary in orientation together according to the prescribed wash pattern.

The nozzle assembly of said at least one wash module may comprise a plurality of separate nozzles commonly directed towards the vehicle and which are movable to vary in orientation together according to the prescribed wash pattern. In this instance, the plurality of nozzles of the nozzle assembly of said at least one wash module may comprise a first nozzle arranged to direct a first jet of fluid onto the vehicle having a first volumetric flow rate at a first pressure and a second nozzle arranged to direct a second jet of fluid onto the vehicle having a second volumetric flow rate which is less than the first volumetric flow rate at a second pressure which is greater than the first pressure. Furthermore, the plurality of nozzles of the nozzle assembly of said at least one wash module may comprise a first nozzle arranged to direct a first jet of water onto the vehicle and a second nozzle arranged to direct a second jet of wash chemical onto the vehicle.

When the prescribed wash pattern defined by the main controller comprises a plurality of prescribed wash surfaces corresponding to surfaces on the vehicle, each of the prescribed wash surfaces is preferably assigned to a respective one of the plurality of wash modules.

When some of the wash modules include a plurality of prescribed wash surfaces associated therewith, said plurality of prescribed wash surfaces may correspond to respective surfaces on the vehicle in proximity to one another to define a collective wash zone of the wash module in which at least some of the wash surfaces within the collective wash zone differ in orientation relative to one another.

Each prescribed wash surface may be defined by the main controller to comprise four corner locations and a quadrilateral area spanning the four corner locations at a prescribed angular orientation relative to the respective wash module.

Furthermore, each prescribed wash surface may comprise a planar surface defined by a plurality of adjacent rows spanning across the planar surface adjacent to one another in which the main controller is arranged to direct each nozzle assembly along a prescribed path which sequentially follows the rows of the planar surface of the respective prescribed wash surfaces associated therewith.

There may be provided an indexer associated with said at least one wash module and arranged to indicate a starting position of the prescribed wash pattern relative to the wash area so as to be arranged to align the prescribed wash pattern with the vehicle in the wash area.

The indexer may be associated with only one of the plurality of wash modules to indicate the starting position of the prescribed wash pattern of said one of the plurality of wash modules relative to the wash area. In this instance, the main controller is preferably arranged to align the prescribed wash patterns of the other ones of the plurality of wash modules relative to the vehicle in the wash area responsive to alignment of the prescribed wash pattern of said one of the plurality of wash modules having the indexer associated therewith relative to the vehicle in the wash area.

The main controller may comprise a plurality of prescribed wash patterns which differ from one another in which each prescribed wash pattern being associated with a different type of industrial vehicle. In this instance, the main controller is preferably arranged to operate said at least one wash module according to a selected one of the plurality of prescribed wash patterns responsive to determination of a type of industrial vehicle in the wash area.

The main controller may be arranged to operate some of the wash modules sequentially with one another according to available water supply.

There may be provided an auxiliary display monitor in communication with an output of the main controller so as to be arranged to display program information to an operator in the control area.

There may be provided two operator inputs in the control area each being associated with some of the plurality of wash modules and each being arranged to vary the prescribed wash pattern of the nozzle assemblies of the wash modules associated therewith.

According to a second aspect of the present invention there is provided a method of washing an industrial vehicle comprising:

locating the industrial vehicle in a wash area;

providing a supply of wash fluid;

providing at least one wash module supported in the wash area, said at least one wash module comprising a nozzle assembly arranged to receive the wash fluid from the supply and direct the wash fluid in a high pressure jet onto the vehicle;

providing a camera associated with said at least one wash module and capturing images of the high pressure jet directed onto the vehicle from said at least one wash module;

displaying the images captured by the camera associated with said at least one wash module on at least one display monitor in a control area separate from the wash area;

varying orientation of the nozzle assembly of said at least one wash module such that the high pressure jet of wash fluid is directed along a prescribed path across the vehicle locations on the vehicle according to a prescribed wash pattern;

varying the prescribed wash pattern of the nozzle assembly of said at least one wash module using an operator input in the control area.

The method may further include varying the prescribed wash pattern of the nozzle assembly of said at least one wash module by: i) interrupting the wash pattern at a prescribed program location; ii) varying orientation of the nozzle assembly of said at least one wash module according to an auxiliary control for a prescribed duration; and iii) resuming the prescribed wash pattern at the prescribed program location when the prescribed duration of the auxiliary control of the wash module is complete.

When there is provided a plurality of wash modules, the method may further include defining the prescribed wash pattern as a plurality of prescribed wash surfaces corresponding to surfaces on the vehicle and assigning each of the prescribed wash surfaces to a respective one of the plurality of wash modules.

The method may further comprise associating a plurality of prescribed wash surfaces with at least some of the wash modules such that said plurality of prescribed wash surfaces correspond to respective surfaces on the vehicle in proximity to one another to define a collective wash zone of the wash module in which at least some of the wash surfaces within the collective wash zone differ in orientation relative to one another.

The method may further comprise defining each prescribed wash surface to comprise four corner locations and a quadrilateral area spanning the four corner locations at a prescribed angular orientation relative to the respective wash module.

The method may further comprise directing each nozzle assembly along a respective prescribed path which sequentially follows a plurality of adjacent rows spanning across the quadrilateral area of each prescribed wash surface associated therewith.

One embodiment of the invention will now be described in conjunction with the accompanying drawings in which:

### BRIEF DESCRIPTION OF THE DRAWINGS

FIG. 1 is a schematic representation of the automated wash system.

FIG. 2 is a schematic representation of the placement of the wash modules relative to a vehicle in the wash area according to a preferred embodiment.

FIG. 3 is a schematic representation of a fixed one of the wash modules.

FIG. 4 is a schematic representation of a mobile one of the wash modules.

FIG. 5 is a flow chart representation of the method of operation of the wash system.

FIG. 6 is a schematic representation of one of the nozzle assemblies.

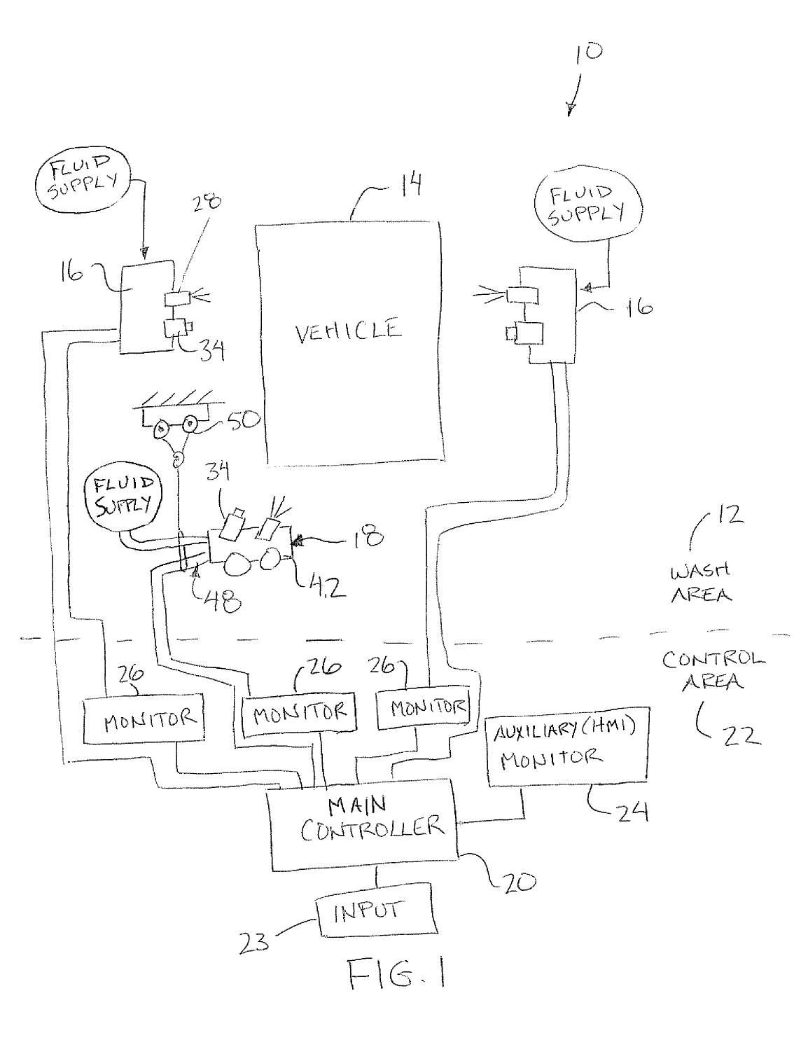

In the drawings like characters of reference indicate corresponding parts in the different figures.

### DETAILED DESCRIPTION

Referring to the accompanying figures there is illustrated an automated wash system generally indicated by reference numeral 10. The system 10 is particularly suited for large industrial vehicles, for example heavy haulers in the mining or earth moving industries.

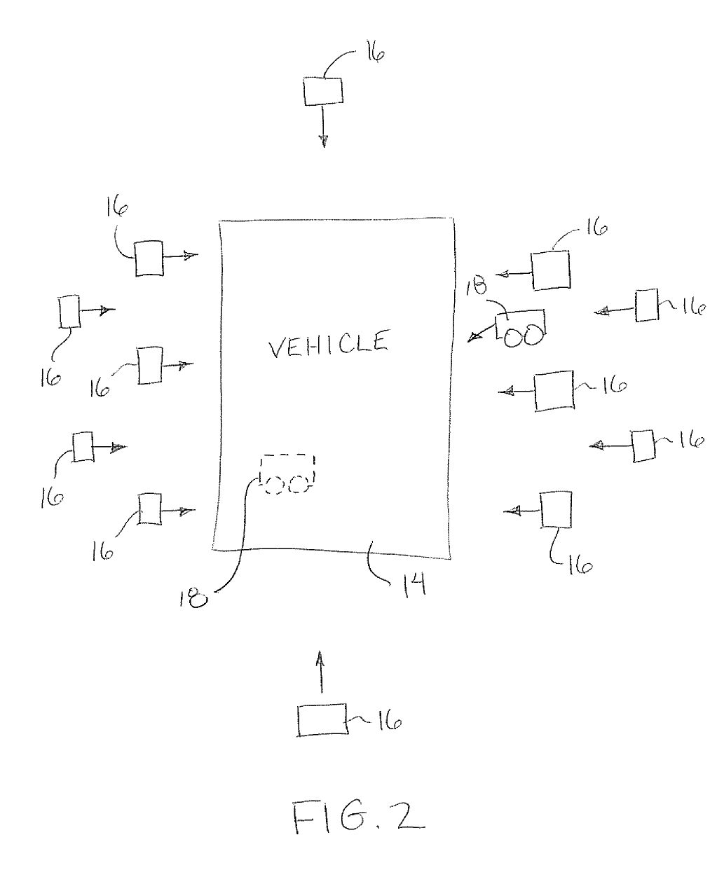

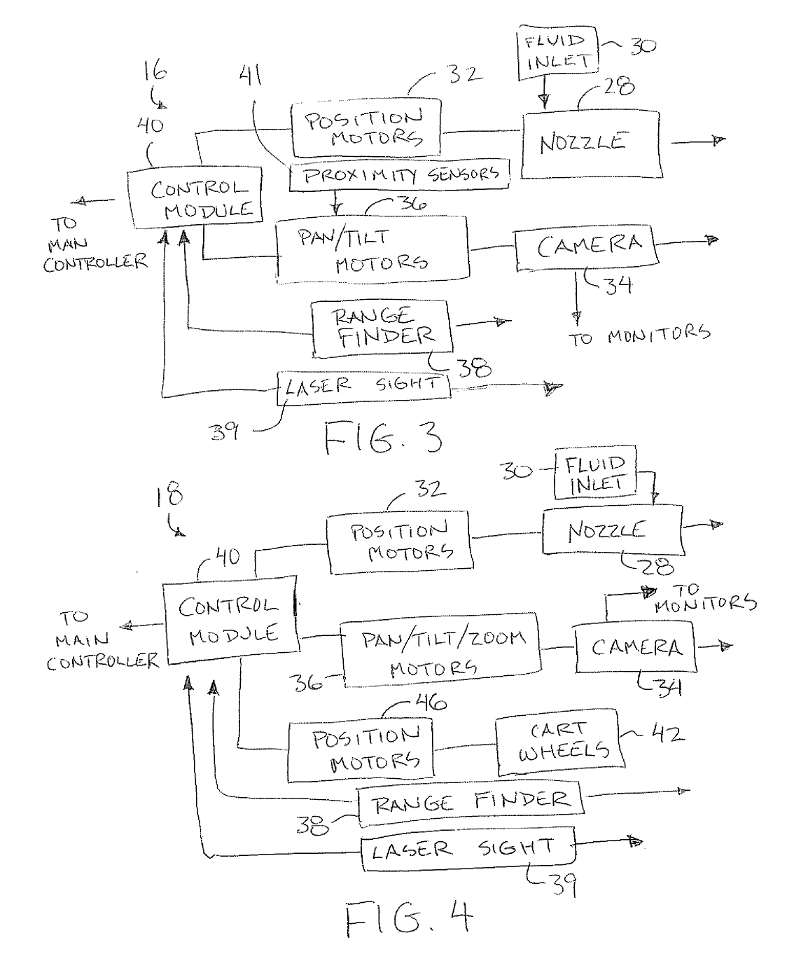

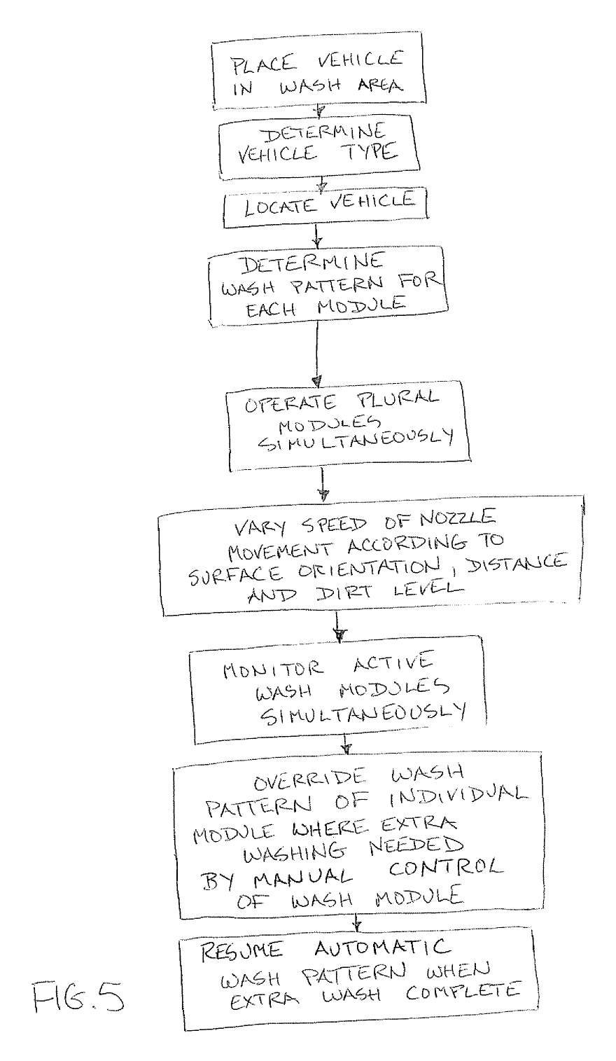

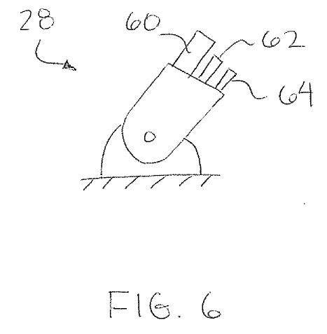

The system 10 is typically housed within a building which defines a wash area 12 for receiving the vehicle 14 therein. According to the illustrated embodiment a plurality of fixed wash modules 16 are located about the perimeter of the wash area to direct respective jets of wash fluid therefrom onto the vehicle. Furthermore, according to the illustrated embodiment of FIG. 2, two mobile wash modules 18 are provided for directing respective jets of fluid therefrom onto the vehicle during the washing operation.

The system further comprises a main controller 20 which is provided in a remotely located control area 22 which is separate from the wash area 12. The main controller 20 receives operator inputs from a common operator input 23 and displays relevant information to the operator through an auxiliary display monitor 24. Also within the control area there is provided a plurality of display monitors 26 such that each monitor is associated with one or more of the wash modules 16 and 18 to provide a continuous display of the jet of fluid from that module which is directed onto the vehicle. When some monitors have plural wash modules associated therewith, all of the wash modules associated with that monitor are typically displayed simultaneously using suitable multiplexing display technology. An operator may also periodically change which cameras are displayed on which monitors to monitor several wash modules through one or more display monitors.

Each fixed wash module 16 includes a nozzle assembly 28 for directing a wash fluid for cleaning the vehicle. The nozzle assembly receives water from a water inlet 30 of the wash module which is connected to a common water supply. The orientation of the nozzle assembly 28 directed at the vehicle of each wash module is directed by respective nozzle assembly motors 32 which serve to adjust height of the nozzle assembly about a horizontal axis and lateral orientation of the nozzle assembly about a vertical axis which in turn controls the direction of the jet of fluid from the nozzle assembly.

The wash fluid is typically water, however various combinations of water and wash chemicals can be used.

The nozzle assembly typically comprises a plurality of nozzles so that water and wash chemical can be dispensed through independent nozzles as may be desired.

Each fixed wash module further comprises a video camera 34 arranged to capture an image of the jet of fluid from the respective nozzle assembly of the wash module. Camera pan and tilt motors 36 are provided for controlling the direction of the camera such that the camera can be controlled to follow the nozzle assembly and provide a continuous image to the respective display monitor 26 in the control area.

The motors 36 of the camera further comprise a zoom control for controlling the zoom of the image captured by the camera.

In some embodiments, the motors 36 controlling movement of the camera and the motors 32 controlling movement of the nozzle assemblies comprise a common motor assembly as the camera and nozzle assembly are typically arranged to be always movable together relative to the vehicle in the wash area. The nozzle assembly and the camera of each wash module are thus movable to vary in orientation together according to the prescribed wash pattern.

Each fixed wash module further comprises a range finder 38 which is used to locate distance to the vehicle from each module during a programming stage of operation.

A laser sight 39 is also associated with each wash module which is movable with the nozzle assembly and camera and serves to pinpoint the location that the nozzle assembly and camera are directed at. At the start of the wash program, one or more wash modules can be reoriented until the laser is directed or indexed to a prescribed starting location relative to the vehicle in the wash area. The vehicle can thus be located relative to the wash area by the orientation of the wash module directed to the prescribed starting location and the other wash modules can be suitably indexed to the prescribed starting location as well automatically by the main controller by determining the relative orientation of the first wash module with indexing laser thereon relative to the wash area.

The laser sight 39 thus comprises an indexer associated with the wash modules and arranged to indicate a starting position of the prescribed wash pattern relative to the wash area so as to be arranged to align the prescribed wash pattern with the vehicle in the wash area. When each of a plurality of wash modules has a prescribed wash pattern associated therewith, the indexer 39 is typically only associated with one of the wash modules to indicate the starting position of the prescribed wash pattern of that wash modules relative to the wash area. The main controller 20 is then arranged to align the prescribed wash patterns of the other ones of the wash modules relative to the vehicle in the wash area responsive to alignment of the prescribed wash pattern of the first wash modules having the indexer associated therewith relative to the vehicle in the wash area.

A control module 40 is provided on each wash module for communicating between the wash module and the main controller. The control module receives information from the range finder 38 as well as receiving positional coordinate information about the nozzle assembly and the camera. The captured image of the camera is relayed back to the monitors in the control area. Under instruction from the programming of the main controller or by manual control and selection by an operator, various control signals for varying the direction of the camera, nozzle assembly or both are communicated from the main controller to the control module which in turn controls the motors 32 and 36 of the wash modules.

Each fixed wash module further comprising proximity sensors 41 which serve to indicate when the end of the range of motion is reached by the cameras or nozzle assemblies to prevent strain on the motors 32 and 36 being attempted to be operated beyond their range of motion.

Each mobile wash module includes all of the features noted above with regard to the fixed wash module supported on a common mobile cart 42 supported on wheels for rolling movement along the ground. The combined components on the cart 42 are arranged to be low in profile so that the cart can be readily received under the vehicle undercarriage.

In addition to the components of the fixed wash module, each mobile wash module further comprises positional motors 46 connected to the wheels of the cart 42 for positioning the cart relative to the vehicle and wash area.

A flexible tether 48 communicates between each mobile wash module and a perimeter location of the wash area to communicate a supply of water to the mobile wash module, along with an electrical power supply for powering the motors on the cart, as well as providing a communicating link between the control module 40 on the mobile wash module and the main controller 20 in the control area. The communication link within the flexible tether communicates the camera images back to the main controller as well as communicating various instructions for control of the nozzle assembly and camera orientations and the cart positions back to the control module 40.

A tether hoist 50 is associated with the tether of each mobile wash unit to suspend the tether above the ground by suspension from the ceiling of the wash area as the tether communicates from the mobile wash module to the perimeter of the wash area. The tether hoist 50 includes various control motors associated therewith for positioning the flexible tether under instructions from the main controller 20.

In the illustrated embodiment of FIG. 2, twelve fixed wash modules 16 are provided and two mobile wash modules 18 are provided. When the vehicle is generally longer in a longitudinal direction, each of two longitudinally extending opposing sides of the wash area are provided with three fixed wash modules evenly spaced apart near ground level. At a second level spaced above the ground level, each of the longitudinally extending sides of the wash area is further provided with two more fixed wash modules spaced apart in the longitudinal direction at substantially the same height so that each second level fixed wash module 16 is generally located between two of the wash modules at the ground level therebelow.

At each of the longitudinally opposed ends of the wash area, there is provided an additional fixed wash module which is centered in the lateral direction between the nozzle assemblies at the longitudinally extending sides. The two fixed wash modules at opposing ends of the area are located at a third level spaced above the intermediate second level and the ground level of the other fixed wash modules to be directed generally downwardly towards the vehicle.

The two mobile wash modules 18 are typically initially positioned at the laterally opposed sides of the vehicle for cleaning the lower portion of the opposed ends of the vehicle as well as the undercarriage of the vehicle. The mobile modules are operable at any number of locations as required to fully wash the underside and the ends of the vehicle.

In a typical configuration, two operator stations are provided within the control area. Each operator station monitors approximately half of the wash modules in the wash area by providing each of two operators with a respective auxiliary display monitor 24 and operator input 23 for interaction with the main controller. Each operator also monitors a respective set of display monitors 26, each having one or more wash modules associated therewith.

In use, a vehicle is initially placed in the wash area. The range finders 38 associated with the wash modules serve to locate the vehicle within the wash area. The laser sight on one or more wash modules is used to locate the prescribed starting position on the vehicle to locate the vehicle relative to the wash area and in turn index the other wash modules to the prescribed starting location. The laser sight is manually guided by an operator to the starting location to indicate to the main controller the starting location of the prescribed wash pattern associated therewith.

The type of vehicle can be input by the operator in the control area, or alternatively suitable sensors can be provided to determine the vehicle type. A prescribed wash pattern for each of the wash modules is determined for each vehicle type so that upon determination of the vehicle, a particular zone can be determined for each wash module in which each zone may comprise one or more wash surfaces identified by the main controller. The main controller thus stores in memory a plurality of prescribed wash patterns which differ from one another in which each prescribed wash pattern is associated with a different type of industrial vehicle. The main controller is arranged to operate the wash modules according to a selected one of the plurality of prescribed wash patterns responsive to determination of a type of industrial vehicle in the wash area.

A wash pattern is identified for each wash surface within each zone of the respective wash module. For each wash surface, the wash pattern consists of defining the wash surface by four corner points which defines a quadrilateral area therebetween having a prescribed size and angular orientation within the wash area. Using the distance of the wash surface from the wash module, the controller determines the path of the jet from the respective nozzle assembly to be followed and at what speed of nozzle assembly movement to completely and evenly cover the wash surface with wash fluid to sufficiently wash the surface and remove any undesirable debris and dirt therefrom. Typically the speed of advancing movement of the jet along the prescribed path of the wash pattern will be slower if distance to the wash surface increases from the wash module or if angular orientation relative to the direction of the jet assumes a more parallel relationship than a perpendicular relationship thereto.

Upon initially starting the wash cycle, each wash module follows the prescribed wash patterns in an automated manner while the associated cameras are moved with the nozzle assemblies to capture an image of the jet of fluid from the nozzle assembly impacting the vehicle continuously on the respective display monitor 26 in the control area. Based on the amount of water available, the main controller 20 will operate the wash modules all together in sequential groups or in an individual sequential manner to operate as many wash modules simultaneously as possible while ensuring sufficient water is available at sufficient pressure to adequate wash vehicles.

During operation of the wash modules to follow respective wash patterns thereof, the operator in the control area watches all active modules on their respective display monitors 26 simultaneously. Where the wash pattern associated with a particular wash zone is sufficient to adequately wash the vehicle, no further operator intervention is required. In the event that the operator notices one area which requires some additional cleaning beyond the cleaning performed by the wash pattern, the operator can use the common operator input 23 with interaction through the auxiliary monitor to select the wash module associated with the area requiring additional cleaning to pause the wash pattern and manually relocate the direction of the nozzle assembly so that the jet of fluid therefrom cleans the area in question. Upon satisfactorily cleaning the area in question, the operator can select resuming the wash pattern for that particular wash module and the wash module will redirect the nozzle assembly to the last completed portion of the wash pattern and continue on with the remainder of the wash pattern. During the manual override of one particular wash module, the remaining wash modules continue to operate according to their prescribed wash patterns. In this manner a single operator can monitor and operate a large number of wash modules simultaneously to considerably decrease the wash time of the vehicle as well as decreasing the operator requirements.

Using the operator input 23, including a tablet PC, computer mouse, keyboard, touch screen and/or a joystick, various particulars of the system can be readily controlled. The main controller can be used to adjust the amount of wash chemical which is mixed with wash water which is directed to each of the wash modules. Further adjustments can be made to the overall amount of cleaning being performed by increasing or decreasing the speed of movement of one or all wash modules along their respective wash patterns. In seasons where larger amounts of dirt and debris accumulate on the vehicles, the wash time can be extended by slowing the advancing speed of the nozzle assembly across the vehicle for example.

Each nozzle assembly typically follows a prescribed pattern of a general diamond shape defined by four points on the vehicle so that each wash surface is generally a quadrilateral shaped area with multiple areas being adjoined with one another to define the respective wash zone of each wash module. The program can further include surfaces or areas to be avoided by the high pressure wash jets from the nozzle assemblies, including areas where sensitive electronic equipment is supported on the vehicle and the like.

The configuration of the jet of wash fluid can be adjusted between various modes including a single point mode focusing the jet on a single point area as well as various rotating and swirling patterns or serpentine back and forth oscillating type patterns. Typically the wash pattern and the pattern of the jets from each nozzle assembly is pre-programmed once of each vehicle type so that the wash program begins by simply selecting the vehicle type and locating the mobile wash units at prescribed starting locations within the wash area.

All of the wash modules are well protected from backspray and debris which may be shed from the vehicle during any washing operation to protect sensitive electronic components of the modules. The mobile wash modules in particular are well protected from impact from the high pressure jets from nozzle assemblies of any of the other wash modules during the washing operation. All equipment in the wash area in general is sufficient robust to withstand the wash chemicals and high pressure spray environment of the wash area.

Using the operator input 23, an operator can control various functions to be selected through interaction with the auxiliary display monitors. When interrupting one of the wash patterns of automatic washing by a particular wash module, the operator can choose to manually guide the nozzle assembly to a desired touch up area, or modification to the existing program can be input. The operator may select auxiliary wash patterns to controllably redirect the nozzle assembly evenly across a particular selected area.

The operator input further allows the operator to control the camera positioning, the camera zoom and other functions of the camera including a camera washing operation to clean the camera lens and thus the image being capture as desired.

When manually overriding the mobile wash modules, the operator can manually select the orientation of the camera and the nozzle assembly thereon in addition to being able to manually position the cart within the wash area. When repositioning the cart within the wash area, the tether hoists can also be controlled manually or in an automatic manner to maintain the tether off the ground.

The operator input can be further used for selecting the amount of wash chemical in some embodiments, and for turning on or off the supplies of wash fluid or wash chemical to one or all of the wash modules.

Typically each nozzle assembly includes a large volume, lower pressure nozzle 60 for performing most of the cleaning operation. A smaller volume, high pressure nozzle 62 is typically associated with the nozzle assembly of each mobile module. A chemical nozzle 64 is typically located alongside each nozzle assembly for mixing wash chemical with the wash fluid. All nozzles are movable in a common direction together with the camera. The plurality of separate nozzles of each nozzle assembly are commonly directed towards the vehicle and are movable to vary in orientation together according to the prescribed wash pattern. As noted above, the nozzles of each nozzle assembly can comprise a first nozzle arranged to direct a first jet of fluid onto the vehicle having a first volumetric flow rate at a first pressure and a second nozzle arranged to direct a second jet of fluid onto the vehicle having a second volumetric flow rate which is less than the first volumetric flow rate at a second pressure which is greater than the first pressure. Furthermore, the plurality of nozzles of each nozzle assembly comprises a first nozzle arranged to direct a first jet of water onto the vehicle and a second nozzle arranged to direct a second jet of wash chemical onto the vehicle.

As described herein, the operator input is arranged to vary the prescribed wash pattern of the main controller by being arranged to: interrupt the wash pattern at a prescribed program location; provide auxiliary control of said at least one wash module for a prescribed duration, and resume the prescribed wash pattern at the prescribed program location when the prescribed duration of the auxiliary control of the wash module is complete. The operator input comprises a manual controller arranged to manually vary orientation of the nozzle assembly of each wash module under operator control during auxiliary control of the wash module.

When using plural wash modules, the prescribed wash pattern defined by the main controller comprises a plurality of prescribed wash surfaces corresponding to different surfaces on the vehicle. Several of the prescribed wash surfaces are typically assigned to each one of the plurality of wash modules. The plurality of prescribed wash surfaces associated with a given wash module will correspond to respective surfaces on the vehicle which are in proximity to one another to define a collective wash zone of the wash module. Generally, each wash surface in the collective wash zone differs in orientation or distance from the other surfaces of that zone.

As further described herein, each prescribed wash surface defined by the main controller, comprises four corner locations and a quadrilateral area spanning the four corner locations at a prescribed angular orientation relative to the respective wash module and relative to the wash area. In this manner, the overall surface of the vehicle is defined as a plurality of individual wash surfaces or planar surfaces which are assembled together to define the outer surface of the vehicle to be washed. More particularly, each prescribed wash surface comprises a planar surface defined by a plurality of adjacent rows spanning across the planar surface adjacent to one another. The main controller directs each nozzle assembly along a prescribed path which sequentially follows the rows of the planar surface of the respective prescribed wash surfaces associated therewith. Upon completing the prescribed path of one surface, the controller relocates the wash module orientation to follow the prescribe path of the next adjacent wash surface until all wash surfaces of the associated wash zone have been covered.

The system 10 is well-suited for installation in a new wash building, or alternatively the system can be readily adapted for retrofitting an existing wash bay area from a manual mode of operation to an automated mode according to the system 10 described herein.

Although the Automated Wash Bay System consists of many components, only the major components have been summarized in the following. The system includes, but is certainly not limited to, the following:

1. Twelve fully automated, fixed (stand pipe mounted) water monitors (cannons). Normal locations would include three monitors per side at ground level (total of six), two monitors per side at level two of catwalk (total of four) and two monitors at level three, one located front center and one at rear center (total of two).

2. Two fully automated roaming water monitors mounted on remote operated carts. Each cart includes skid steer drive train, joy stick or portable tablet PC control and a tether hoist attached to the ceiling allowing for the ability to retract the cart tether, keeping it off the floor as the cart operates within the work area (tether is comprised of water, cleaning fluid and electrical lines).

All monitors include the following: Servo Motor Power, Minimal Backlash Gear Boxes, Mounted Camera, Mounted Camera Wash, Range Finder Mounting Bracket (required for wash zone setup only), Required Proximity Sensors and Mounting Brackets, Cleaning Fluid Delivery System, Monitor Control Cabinet, Water Control Valve, Control Room Hardware & Software (hardware quantities and software capabilities are based on having the system controlled by two wash bay technicians), State of the Art Video Surveillance System (fully integrated with the wash bay control system), Multi-Function Joy Stick Control, water monitor selection, water monitor pan & tilt with integrated speed control, camera control (zoom, lens wash), water control (on-off), remote operated cart control, hoist control for remote operated cart tether, Wash Bay Control System Software License, Third Party Software Licenses, All PC & PC Based Networking Components, All Video Monitoring Equipment Related to PC Based Control System and Video, Surveillance System, eg. flat screen monitors, Portable Tablet PC (for control of the wash bay system when operators are not located in the control room), Remote Access Capability for Service and Trouble Shooting Support, Power Distribution Control Cabinet to Supply all Monitors, PLC Control Cabinets (for control of all wash bay related functionality).

The wash bay control system software supports multiple monitors, all washing simultaneously. The multi-user interface is picture and graphic based, with easy to follow screen prompts. Data storage is contained within the system data base and the auto-wash setup is query based. Once the auto-wash setup is complete and the wash cycle has commenced, the primary auto-wash functions will be carried out by use of the multi-function joy stick. Monitors can be grouped, taken off line, started or stopped independently, or as a group. Functionality supports seasonal variances in wash characteristics; wash, rinse, cleaning fluid application and speed control. The custom software has been designed and written with ease of use as the underlying principal and the end result is a very user friendly system. Operating the system is not unlike playing a video game.

It is believed that a primary benefit derived from the present invention is the dramatically increased throughput in the wash bay process. Increased throughput means less downtime per truck and the resulting increased level of productivity. The following is an example using a total of fourteen water monitors (Cannons), in an existing wash bay.

This calculation is based on six hours of water-on time.

6 hrs of water-on time×2 technicians=720 minutes wash time

720 minutes|14 monitors=51 minutes per monitor

Assume water capacity allows for 6 monitors to be running at one time

14|6=2.5 cycles

2.5 cycles×51 minutes=128 min/60=2.2 hours+2 hours for manual touch-up (4 man hrs based on 2 techs)

Total time to clean average truck 4.2 hours

24 hrs/day 14.2 trucks=6 trucks cleaned per day 6-8 trucks per day (summer, winter, fall)

4-5 trucks per day (spring)

As further described herein, the automated wash monitor is a system of integrated components consisting of a water monitor (cannon), motor drive control cabinet, the control panel with joystick anal computer peripherals, and the portable HMI tablet PC.

Features of the system include: Tablet PC, HMI PC and joystick input, Touch screen control, Intelligent graphic/picture based interface, Two step cart placement/positioning, Seasonal wash selection modes, Zones can be created in any vertical or horizontal orientation, 360° horizontal sweep and 270° degree vertical sweep around monitor, Intuitive query engine for zone selection, Zones can be stitched together to form larger areas and one-shot zones allow water to be concentrated on a single point for a specified time, Zones are stored for future use and can be edited, On the fly speed adjustment, Three types of water movement during auto-wash—swirling, serpentine (back and forth) and one-shot, Manual washing capability (within an auto-wash cycle), Automated water control valve, Automatic sequencing of active monitors (depending on water supply capability), Monitor mounted camera with zoom function and lens cleaning, Chair mountable joystick for monitor/rover, control featuring: monitor/motorized cart control switch, pause/resume monitor motion, water on/off, select monitor to Control, camera, zoom in/out and wash.

Benefits of the automated wash system include: Multiple input options for detailed (HMI) or simple (joystick) control options, Tablet PC permits remote operation, Multiple joystick options, Requires minimal training, Fast setup, Permits quick selection of heavy or light cleaning, Allows for washing almost any surface within a monitor centred spherical envelope, Minimal zone placement restriction, Fast wash cycle setup, Larger non-continuous areas can be washed while avoiding critical no-wash areas, One-shot zones allow for washing points that require extra attention, Quick zone selection/recognition allows fast setup, Operator can adjust speed as required, Allows for thorough, fast or concentrated washing, Operator can focus on areas that require extra washing, Allows automatic and manual water flow control via system interface, Single or multi monitor activity, Allows operator controlled viewing of wash surface, Flexible control options with fingertip access to all major auto-wash functions for any active monitor.

Custom options include: Motorized remote operated cart or push-in-place cart—fixed standpipe mounted monitor is standard, Database supports unlimited storage of monitors, zones and vehicle types, Cleaning solution delivery, Pump room control and monitoring, Waste water sump control & monitoring, Custom designed system alarming (HMI), Customized HMI graphics, Wash bay safety & system control integration (into HMI)—e.g. bay door opening/closing etc., Control Room design/consultation, High pressure wash for sport cleaning.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A wash system for an industrial vehicle comprising:
a wash area arranged for receiving the industrial vehicle therein;
a supply of wash fluid;
at least one wash module supported in the wash area, said at least one wash module comprising a nozzle assembly arranged to receive the wash fluid from the supply and direct the wash fluid in a high pressure jet onto the vehicle;
a camera associated with said at least one wash module and arranged to capture images of the high pressure jet directed onto the vehicle from said at least one wash module;
a control area separate from the wash area and arranged to receive an operator therein;
at least one display monitor in the control area arranged to display the images captured by the camera associated with said at least one wash module;
a main controller arranged to controllably vary orientation of the nozzle assembly of said at least one wash module according to a prescribed wash pattern; and
an operator input in the control area arranged to selectively vary the prescribed wash pattern of the nozzle assembly of said at least one wash module responsive to an input from an operator in the control area.

2. The system according to claim 1 wherein the operator input is arranged to vary the prescribed wash pattern of the main controller by being arranged to: interrupt the wash pattern at a prescribed program location; provide auxiliary control of said at least one wash module for a prescribed duration, and resume the prescribed wash pattern at the prescribed program location when the prescribed duration of the auxiliary control of the wash module is complete.

3. The system according to claim 2 wherein the operator input comprises a manual controller arranged to manually vary orientation of the nozzle assembly of said at least one wash module under operator control during auxiliary control of said at least one wash module.

4. The system according to claim 1 wherein said at least one wash module comprises a plurality of wash modules, each having a prescribed wash pattern, the main controller being commonly associated with the plurality of wash modules so as to be arranged to operate at least some of the plurality of wash modules simultaneously with one another and so as to be arranged to independently control each of the wash modules according to the respective prescribed wash pattern thereof.

5. The system according to claim 1 wherein said at least one wash module comprises a plurality of wash modules, the operator input being arranged to selectively vary the prescribed wash pattern of the nozzle assembly of a selected one of the plurality of wash modules and the main controller being arranged to operate at least some of the other ones of the plurality of wash modules according to the respective prescribed wash pattern thereof during operation of the operator input to vary the prescribed wash pattern of the selected one of the wash modules.

6. The system according to claim 1 wherein said at least one wash module comprises a plurality of wash modules supported at fixed locations about a perimeter of the wash area, the nozzle assembly of each wash module being supported to vary orientation of the nozzle assembly at the respective fixed location thereof.

7. The system according to claim 1 wherein: said at least one wash module comprises a mobile wash module supported on a cart for rolling movement along the ground; the cart comprises a position motor arranged to selectively position the cart within the wash area; and the main controller is arranged control the position motor to position the cart according to the prescribed wash pattern

8. The system according to claim 1 wherein the nozzle assembly and the camera of said at least one wash module are movable to vary in orientation together according to the prescribed wash pattern.

9. The system according to claim 1 wherein the nozzle assembly of said at least one wash module comprises a plurality of separate nozzles commonly directed towards the vehicle and which are movable to vary in orientation together according to the prescribed wash pattern, the plurality of nozzles of the nozzle assembly of said at least one wash module comprises a first nozzle arranged to direct a first jet of fluid onto the vehicle having a first volumetric flow rate at a first pressure and a second nozzle arranged to direct a second jet of fluid onto the vehicle having a second volumetric flow rate which is less than the first volumetric flow rate at a second pressure which is greater than the first pressure.

10. The system according to claim 1 wherein the nozzle assembly of said at least one wash module comprises a plurality of separate nozzles commonly directed towards the vehicle and which are movable to vary in orientation together according to the prescribed wash pattern, the plurality of nozzles of the nozzle assembly of said at least one wash module comprises a first nozzle arranged to direct a first jet of water onto the vehicle and a second nozzle arranged to direct a second jet of wash chemical onto the vehicle.

11. The system according to claim 1 wherein said at least one wash module comprises a plurality of wash modules and the prescribed wash pattern defined by the main controller comprises a plurality of prescribed wash surfaces corresponding to surfaces on the vehicle, each of the prescribed wash surfaces being assigned to a respective one of the plurality of wash modules.

12. The system according to claim 11 wherein at least some of the wash modules include a plurality of prescribed wash surfaces associated therewith, said plurality of prescribed wash surfaces correspond to respective surfaces on the vehicle in proximity to one another to define a collective wash zone of the wash module in which at least some of the wash surfaces within the collective wash zone differ in orientation relative to one another.

13. The system according to claim 11 wherein each prescribed wash surface is defined by the main controller to comprise four corner locations and a quadrilateral area spanning the four corner locations at a prescribed angular orientation relative to the respective wash module.

14. The system according to claim 11 wherein each prescribed wash surface comprises a planar surface defined by a plurality of adjacent rows spanning across the planar surface adjacent to one another, the main controller being arranged to direct each nozzle assembly along a prescribed path which sequentially follows the rows of the planar surface of the respective prescribed wash surfaces associated therewith.

15. The system according to claim 1 wherein there is provided an indexer associated with said at least one wash module and arranged to indicate a starting position of the prescribed wash pattern relative to the wash area so as to be arranged to align the prescribed wash pattern with the vehicle in the wash area.

16. The system according to claim 15 wherein said at least one wash module comprises a plurality of wash modules, each having a prescribed wash pattern associated therewith and wherein the indexer is associated with one of the plurality of wash modules to indicate the starting position of the prescribed wash pattern of said one of the plurality of wash modules relative to the wash area, the main controller being arranged to align the prescribed wash patterns of the other ones of the plurality of wash modules relative to the vehicle in the wash area responsive to alignment of the prescribed wash pattern of said one of the plurality of wash modules having the indexer associated therewith relative to the vehicle in the wash area.

17. The system according to claim 1 wherein the main controller comprises a plurality of prescribed wash patterns which differ from one another, each prescribed wash pattern being associated with a different type of industrial vehicle, the main controller being arranged to operate said at least one wash module according to a selected one of the plurality of prescribed wash patterns responsive to determination of a type of industrial vehicle in the wash area.

18. A method of washing an industrial vehicle comprising:
locating the industrial vehicle in a wash area;
providing a supply of wash fluid;
providing at least one wash module supported in the wash area, said at least one wash module comprising a nozzle assembly arranged to receive the wash fluid from the supply and direct the wash fluid in a high pressure jet onto the vehicle;
providing a camera associated with said at least one wash module and capturing images of the high pressure jet directed onto the vehicle from said at least one wash module;
displaying the images captured by the camera associated with said at least one wash module on at least one display monitor in a control area separate from the wash area;
varying orientation of the nozzle assembly of said at least one wash module such that the high pressure jet of wash fluid is directed along a prescribed path across the vehicle locations on the vehicle according to a prescribed wash pattern;
varying the prescribed wash pattern of the nozzle assembly of said at least one wash module using an operator input in the control area.

19. The method according to claim 18 including varying the prescribed wash pattern of the nozzle assembly of said at least one wash module by: interrupting the wash pattern at a prescribed program location; varying orientation of the nozzle assembly of said at least one wash module according to an auxiliary control for a prescribed duration; and resuming the prescribed wash pattern at the prescribed program location when the prescribed duration of the auxiliary control of the wash module is complete.

20. The method according to claim 18 wherein said at least one wash module comprises a plurality of wash modules, the method including:
defining the prescribed wash pattern as a plurality of prescribed wash surfaces corresponding to surfaces on the vehicle and assigning each of the prescribed wash surfaces to a respective one of the plurality of wash modules;
associating a plurality of prescribed wash surfaces with at least some of the wash modules such that said plurality of prescribed wash surfaces correspond to respective surfaces on the vehicle in proximity to one another to define a collective wash zone of the wash module in which at least some of the wash surfaces within the collective wash zone differ in orientation relative to one another;
defining each prescribed wash surface to comprise four corner locations and a quadrilateral area spanning the four corner locations at a prescribed angular orientation relative to the respective wash module; and
directing each nozzle assembly along a respective prescribed path which sequentially follows a plurality of adjacent rows spanning across the quadrilateral area of each prescribed wash surface associated therewith.
